(19) United States
(12) Patent Application Publication
(10) Pub. No.: US 2016/0186534 A1
(43) Pub. Date: Jun. 30, 2016

(54) SUBSEA SYSTEM COMPRISING A CRAWLER

(71) Applicant: FMC KONGSBERG SUBSEA AS, Kongsberg (NO)

(72) Inventors: Arne Tyler SCHILLING, Davis, CA (US); Steven Mark COHAN, Davis, CA (US)

(21) Appl. No.: 14/902,840

(22) PCT Filed: Jul. 5, 2013
(86) PCT No.: PCT/IB2013/001966

§ 371 Date: Jan. 4, 2016

(51) Int. Cl. E21B 41/04; B63B 35/44; B60L 11/18; B63C 11/52

(52) U.S. Cl. CPC E21B 41/04; B63C 11/52; B63B 35/44; B60L 11/182

(57) ABSTRACT

A subsea system comprising a subsea installation having at least one negotiable surface and at least one recharge station, at least one crawler freely movable on the surface of the subsea installation, and wherein each crawler has rechargeable means for charging by at least the recharge station.

### FIELD OF THE INVENTION

The invention concerns a subsea system, and more particularly a subsea system comprising a crawler.

### BACKGROUND OF THE INVENTION

A need exists in the oil industry to reduce the complexity of installed production equipment and thereby improve the reliability of the system whilst reducing cost and weight. There is also a need to provide efficient and effective means to remotely maintain, improve reliability of, and increase commonality across all subsea infrastructures of varying sizes and complexities, in all regions. There is also a need to provide a system for sensing and actuation in subsea production systems that is cost efficient and not too complex, and at the same time provides increased reliability of subsea production control systems. This is also relevant in remote and difficult-to-reach locations, such as the arctic.

One possible way of providing sensing or actuation is to provide equipment with fixed sensors/actuators and signal/control lines to a control unit, possibly subsea with an umbilical to topside, or alternatively with a control unit topside. Other types of prior art solutions include projects such as Saab SeaEye and studies by companies like International Submarine Engineering, Lockheed Martin and Cybernetix. Most of these studies include the use of technology including AUVs (Autonomous Underwater Vehicle) intended to primarily provide inspection-based services. The operational envelopes of the AUVs are limited by battery technology and the lack of technology in relation to high bandwidth communication through water. The “Swimmer” concept by Cybernetix provides some level of intervention capability, possibly allowing a resident system to utilize field-provided power and communications infrastructure. However, the concept does not address the need for communicating with a wide range of sensors in the subsea infrastructure, as it needs a large vessel for deployment of the vehicle. In addition, it has not been designed to effectively maintain the subsea hardware.

Another prior art solution is to use standard known ROV systems which can perform a wide variety of tasks. Using manipulators and various equipment, including hydraulic torque tools, ROV operators regularly perform tasks including valve operation, visual inspections, corrosion protection (CP) readings, hot stab operations, and assistance with module replacements such as, e.g., connection of running tools or lift lines to subsea control modules (SCM) or other modules.

Oil companies desire an alternative to the ROV/AUV-based systems, as vessels must be hired for extended periods of time in most cases, thus incurring significant expense. Additionally, for fields that are inaccessible by typical vessels for limited or longer time periods during the year, e.g., in the arctic, ROV intervention will not be possible. These known systems also do not address the need for reduced complexity of installed production equipment.

An object of the present invention is to reduce complexity of installed production equipment, and thereby also improve the reliability of the system. Another aim is to reduce cost and weight of the installed production equipment. Another objective is to reduce the cost and maintenance difficulties, as well as increase the capabilities of subsea production control systems.

Yet another objective is to reduce the complexity of sensing and actuation in subsea production systems.

Yet another objective is to provide a system where some of the difficulties with known systems are alleviated or reduced.

### SUMMARY OF THE INVENTION

The present applicant has devised and embodied a solution for limiting, or even eliminating, the needs of complex functionality in the subsea system. The system according to the invention may significantly reduce the installed infrastructure whilst enabling shared actuation and repair/replacement functionality resident on the subsea structure. The present invention also provides a system for sensing and control and or actuation in a subsea production system, and at the same time increases the reliability of subsea production control systems and the commonality of components used in them.

The invention is set forth and characterized in the independent claim, while the dependent claims describe other characteristics of the invention.

The subsea system according to the invention may solve a number of tasks on a conventional subsea installation plant, including actuation of valves, performance of surveillance and/or inspections, including noise, vibration and visual inspections using, e.g., a camera, and/or the performance of function as the control unit for a number of different subsea applications, either for a limited or an extended time due to malfunction in the main control system or due to the need for performing other/additional tasks.

The invention relates to a subsea system comprising: a subsea installation having at least one negotiable surface and at least one recharge station, at least one crawler freely movable on the negotiable surface of the subsea installation, and wherein each crawler has rechargeable means for charging by at least the recharge station.

The one negotiable surface may be a planar or to some extend curved surface, provided that the crawler has an attachment system for being in contact with the surface. The surface may be an inside or outside surface, possibly oriented in any direction, including vertical and horizontal. The surface may be substantially planar. The surface may also comprise different kinds of sections, some planar and some transition sections with curvature forming a common substantially planar surface. The negotiable surface has to be of a kind whereon the crawler can freely move and keep contact with the surface. Dependent on the crawler, the surface may have a larger or smaller curvature of the surface whereon the crawler should move.

In an embodiment of the invention, the subsea installation may further comprise at least one umbilical termination head, and the umbilical termination head may be connected to at least one power source and may have wireless communication means, wherein the at least one recharge station may form part of the umbilical termination head.

In an embodiment of the subsea system, the at least one crawler may have communication functions and rechargeable elements for communication with the wireless communication means and the recharge station on the umbilical termination head, respectively. The communication functions may also be adapted for communication with other components in the subsea structure. These other component may also be other crawlers in the subsea system. The communication functions may also be used for communication with systems temporarily positioned subsea, such as ROVs, intervention systems etc. These communication functions may be wireless communication and/or plug-in systems for communication. By having the crawler able to communicate with several elements provides the possibility for the crawler to move around and pick up information from several units, transfer these to a central unit for communication with an operator, and also transfer communications back to the several units.

According to another aspect, at least one crawler may comprise a control module pack, adaptable to control subsea systems to which the crawler attaches. With such a system the subsea installation needs only a limited number of control units, as the crawler with the control module pack may move around between different elements that need to be controlled and or operated at different times. The control module pack may also be a substitute for having a backup system on each element in case of failure in a fixed control unit. By having a number of crawlers with a control unit pack, these may, when a failure occurs, move to the given place and connect and thereby be the backup until a scheduled maintenance is performed.

At least one crawler in the subsea system may further comprise operating devices for manipulating subsea components, such as opening and closing manual valves and/or actuating valves or other elements. This results in the valve/element structure in a subsea system being less complex, as one may reduce the numbers of fixed actuators and possibly also backup systems for these actuators, since the crawlers may act as the backup system.

In an aspect of the invention, the at least one crawler may have sticking means. The sticking means are sticking elements which connect and keep the crawler connected to the negotiable surface. Such means may be magnets, a tape system, suction cups or similar devices making it possible to move the crawler in all directions along the surface of any subsea structure having substantially plane surfaces such that the crawler is movable horizontally on a top surface, upside-down under a surface, along a side wall, i.e. vertically, etc.

In an embodiment the at least one crawler may have propulsion means. The sticking means may in one embodiment be arranged on the propulsion means, e.g., on the wheels, belts etc., or as part of the crawler body.

In an aspect of the invention, the power source may be a subsea turbine, surface equipment which is connected to the crawler through an umbilical, a thermocouple, a battery pack, etc. The battery pack may then at intervals be recharged or replaced. Another option is to have the battery pack continuously charged by a thermocouple or other element providing a small charge per time unit.

In one embodiment, the operating devices may comprise an extendable torque tool for manipulating, e.g. valves.

In an aspect of the subsea system, the at least one crawler may further comprise navigation cameras. In another embodiment the crawler may have other or additional navigation means different from navigation cameras, such as sonar, laser positioning, swag points, tags, and acoustics. Alternatively the crawlers may be (pre)-programmed to follow a specific safe route avoiding obstacles, e.g., a pathway. The crawler may also be provided with a positioning device, providing signals to its position and receiving corrections if moved outside safe routes. In an aspect, the propulsion means may comprise casters or wheels. Alternatively, the propulsion means may be propellers for moving the crawler forward, while the sticking means are wheels or other elements keeping the crawler attached to the surface.

In an embodiment, the recharge station and the rechargeable means are inductive. This may be achieved by resonant inductive couplings which are connected. The recharging may be by plug-in systems and/or wireless.

In an embodiment of the subsea system according the invention, the umbilical termination head may be provided with a guiding arrangement for cooperation with an extending portion on the crawler for charging. The guiding arrangement may also comprise the recharging system.

According to another aspect of the invention, the system may also comprise at least one crawler comprising an umbilical connected to the subsea structure. This may be used in the case the crawler must be able to operate several elements positioned closely together.

In a preferred embodiment, the surfaces of the subsea structure are negotiable or substantially planar, such that the crawler may move freely without obstruction on the entire surface of the subsea structure or on dedicated pathways.

In one embodiment, the solution according to the present invention renders possible the use of less costly manual valves. The valves used may be valves operable by ROVs, rendering it unnecessary to design new valves.

Alternatively, the valves may be made less complicated as crawlers are more stable relative to the valves than an ROV (that is, they are only movable in 2D in comparison with 3D). In any design, the crawler may be equipped with a torque tool or a hydraulic actuation tool making the crawler able to manipulate valves and/or hydraulic actuators on the subsea structure.

According to an aspect of the invention, the interfaces of the elements to be operated by a crawler, for instance the valves, may in one embodiment be arranged as recesses below the surface of the subsea structure such as to avoid the crawlers being obstructed by these interfaces. In this embodiment, the crawlers made for manipulating valves may have a torque tool that is retracted above the surface of the subsea structure when in a non-operating position, and is extended down below the surface of the subsea structure in an operating position, such as to manipulate the valve. The crawler may then position itself relative to the interface and then activate the tool.

There may be numerous crawlers in the same subsea system, and the different crawlers may have different properties and tasks. The crawlers may work alone, in pairs, or be part of a larger group of crawlers to perform operations that require, e.g., more power, torque capacity, etc. Such operations may include opening or closing of larger valves, movement of subsea elements, replacement of modules, etc.

The crawlers may have one or more of the following properties: recharging means for charging itself, and/or other crawlers and/or other subsea equipment, wireless communication means, inspection means such as a camera, noise detection, vibration detection, torque tools, hydraulic tools, storage capacity for transferring data from sensors to the main control system or similar, and onboard units which function as a part of a control system. By having the crawlers equipped with an onboard control system, one may reduce the need for full control systems at several places in the subsea system, as the crawler may move around and connect itself to different subsea equipment and thereby provide a control module for the subsea system. The crawler with the onboard control system may also be used as temporary backup systems for other control modules subsea. If an error occurs, a crawler may attach itself to the system, thereby providing a backup for the control system until maintenance may be performed. A crawler may also be equipped with handling means to pick up smaller replaceable elements from storage and replace a malfunctioning element in the subsea system.

The crawlers may have means for wireless communication with a termination head and/or for communication with other crawlers and possibly also an operator. The termination head may receive data from the crawler and/or give instructions/data to the crawler. This communication may also be transferred with a plug-in solution. The termination head may have charging means, e.g., a recharge station, for charging the crawler with power, e.g., electrically through a plug-in solution or through wireless power transfer, e.g., inductive charging. The charging means may also have data-transmission properties for sending or receiving data to and from the crawler.

The recharging means may be rechargeable batteries or similar devices.

One crawler may recharge other crawlers, either directly through power produced in its own power generating system, or, alternatively, by first charging the rechargeable battery at the termination head and then recharging the other crawler. After such operations, the crawler that has performed the charging may return to the termination head, e.g., for re-supply of power or for performing other tasks.

The power for the termination head may be delivered through a subsea umbilical or be obtained through an umbilical or wires from the surface, the surrounding seawater, a subsea power plant, a subsea turbine, or energy generated from a well stream, thermocouple, battery, etc.

The crawlers may be provided with ROV-lifting means, such that if a crawler is damaged or for some reason is malfunctioning, it may be lifted to the surface by a ROV or similar device for repair.

In an embodiment of the invention, the subsea system comprises sensor modules. The sensor modules are preferably self contained units designed to perform low power, low bandwidth sensor functions like temperature, vibration and pressure reporting.

The subsea system may also comprise crawlers having means for cleaning the surface of the subsea installation.

According to another aspect the subsea system may comprise a subsea installation and a subsea structure with a pathway forming a negotiable surface between the installation and the structure. The subsea structure is in such a system a subsea installation without the recharging station. In such a setting one may envisage that one crawler is positioned on the subsea structure, for instance as a backup control module, which then is recharged by another crawler, moving at intervals between the crawler at the subsea structure and a recharge station at a subsea installation, using the pathways in the system.

In an aspect, the system may comprise a tool storage device which is accessible for the crawler to retrieve.

In an aspect, the crawler may have means for wireless power transfer to and from the umbilical termination head, another crawler or a power source.

### BRIEF DESCRIPTION OF THE DRAWINGS

These and other characteristics of the invention will be clear from the following description of a preferential embodiment, given as a non-restrictive example, with reference to the attached drawings, wherein:

FIG. 1 is a front perspective view of an embodiment of a crawler according to the present invention with a torque tool in a retracted position;

FIG. 2 is a side view of the crawler in FIG. 1;

FIG. 3 is a side view similar to FIG. 2 but with the torque tool in an extended position;

FIG. 4 is a perspective view of a crawler on a subsea structure parked at a termination head;

FIG. 5 is a perspective view of the crawler on a subsea structure on its way to or from the termination head;

FIG. 6 is a perspective view of the crawler with the torque tool in an extended position manipulating a valve;

FIG. 7 is a perspective view of the crawler parked at an actuator;

FIG. 8 is a perspective view of the crawler venturing over the side of a subsea structure;

FIG. 9 is a perspective view of the crawler on a vertical surface of a subsea structure;

FIG. 10 is a perspective view of an embodiment of a termination head;

FIG. 11 is a perspective view of an example of an actuator according to the invention;

FIG. 12 is an example of the view from a forward navigation camera on a crawler;

FIG. 13 is a schematic view of examples of four pathways for the crawler on the subsea system; and

FIG. 14 is a perspective view of an embodiment of a torque tool according to the invention.

### DETAILED DESCRIPTION OF THE INVENTION

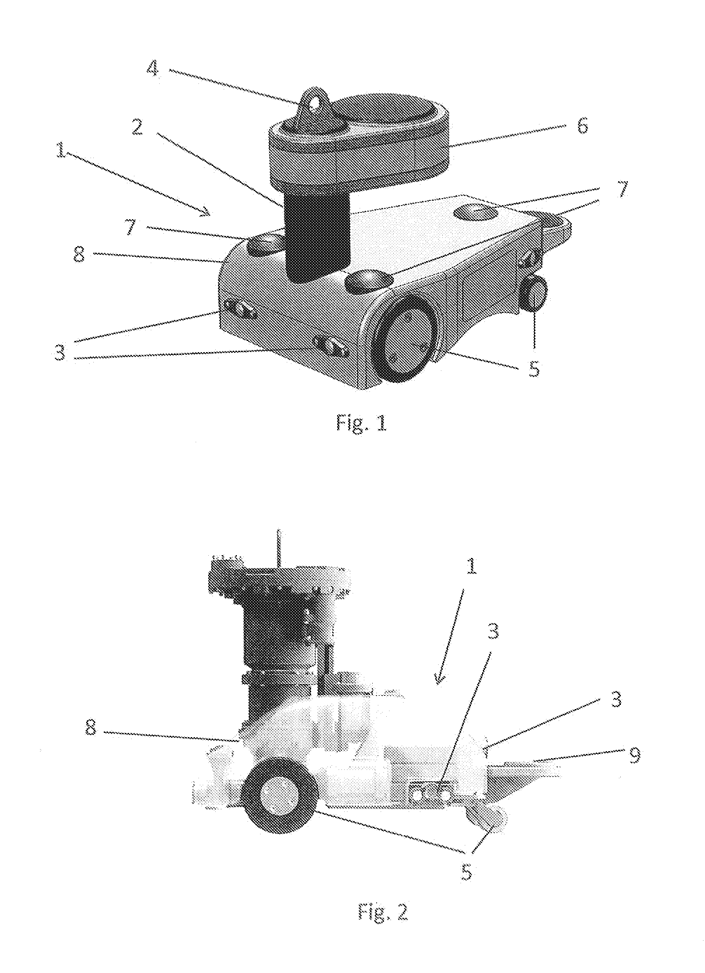

FIG. 1 discloses a crawler 1 according to an embodiment of the present invention. The crawler 1 includes a crawler body 8, a torque tool 2 and a torque tool motor 6. In the shown embodiment the torque tool 2 is in a retracted position. Further, the crawler 1 is provided with a plurality of wheels 5. The wheels 5 and/or the body 8 may be made of a magnetic material or other sticking means such that they will stick to a surface (not shown). The body 8 of the crawler 1 may in a preferred embodiment comprise a control system, batteries, locomotion drives, etc. (not disclosed in the Figures). The crawler 1 is provided with cameras 3 for, e.g., navigation or inspection. Wireless communication means, exemplified as a number of Wi-Fi antennas 7, are arranged on the body 8 of the crawler 1 for wireless communication with, e.g., a termination head, other crawlers, and/or a control system (no one of which is disclosed in FIG. 1). The wheels 5 provide 360 degree maneuverability of the crawler 1 along a surface. The crawler 1 has lifting means 4 such that it can be lifted to the surface for, e.g., maintenance, repair, or other purposes.

FIG. 2 shows the crawler 1 of FIG. 1 with a charging coupling 9 for, e.g., inductive/electric charging and/or charging of hydraulic power.

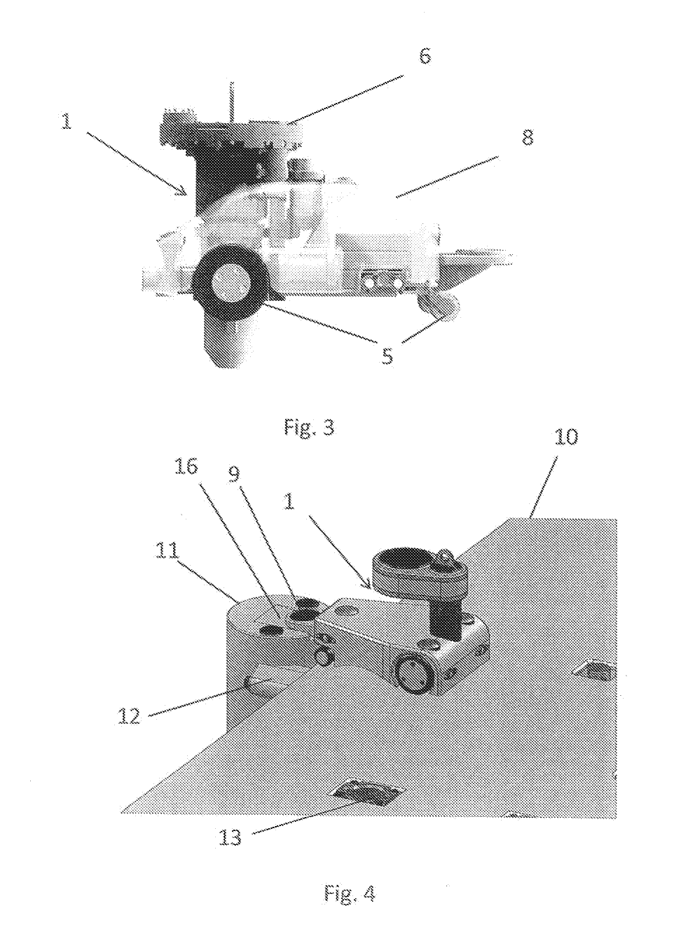

FIG. 3 shows the torque tool 2 in an extended position. The torque tool 2 and the torque tool motor 6 have been moved relative to the crawler body 1 in relation to the position shown in FIGS. 1 and 2.

FIG. 4 shows the crawler 1 on a subsea structure 10 when the crawler is parked at a recharge station 16 in a termination head 11. The subsea structure 10 has plane surfaces making it easy for the crawler 1 to move around in any direction. The termination head 11 has fastening means 12 for connection to the subsea structure 10. FIG. 4 also shows a valve 13 on the subsea structure 10 which may be manipulated by the torque tool 2 on the crawler 1.

FIG. 5 shows the same as FIG. 4, but in this Figure the crawler 1 has left, or alternatively, is entering, the termination head 11. A number of valves 13 are disclosed in the foreground and a number of sensor modules 15 are shown in the background. The sensor modules 15 are a self-contained units designed to perform low power, low bandwidth sensor functions like temperature, vibration and pressure reporting. The sensor modules 15 may comprise a wireless communication means, an energy harvesting module, a connection to production fluids, transducers and control electronics.

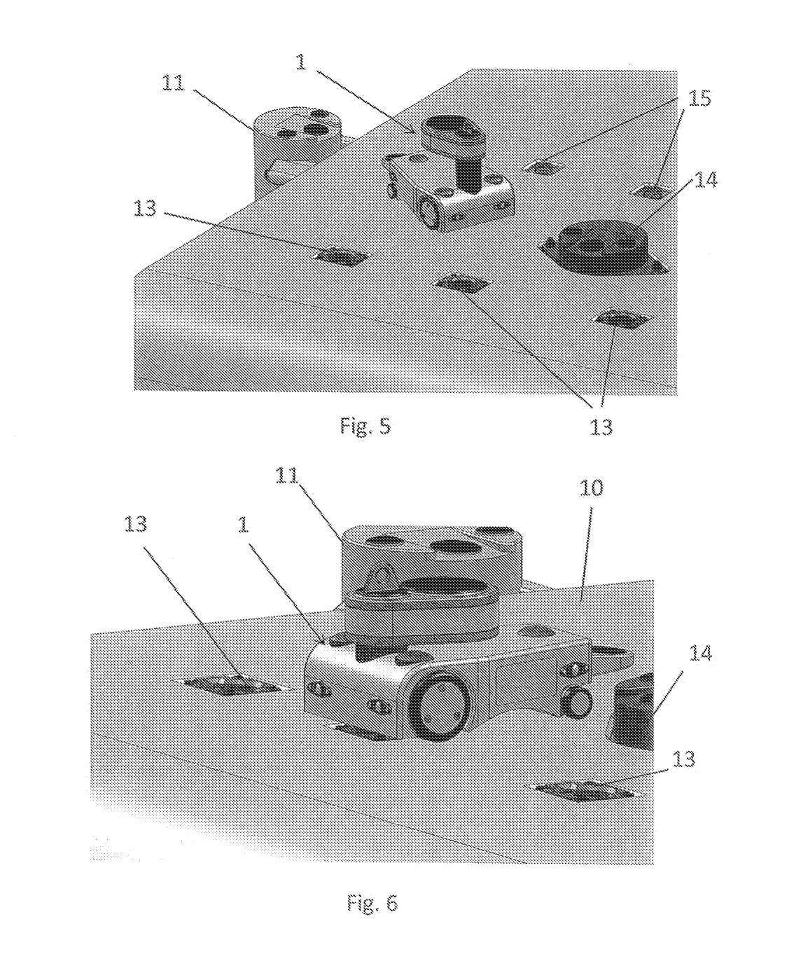

FIG. 6 shows the crawler 1 with the torque tool 2 in an extended position manipulating a valve 13 on the subsea structure 10.

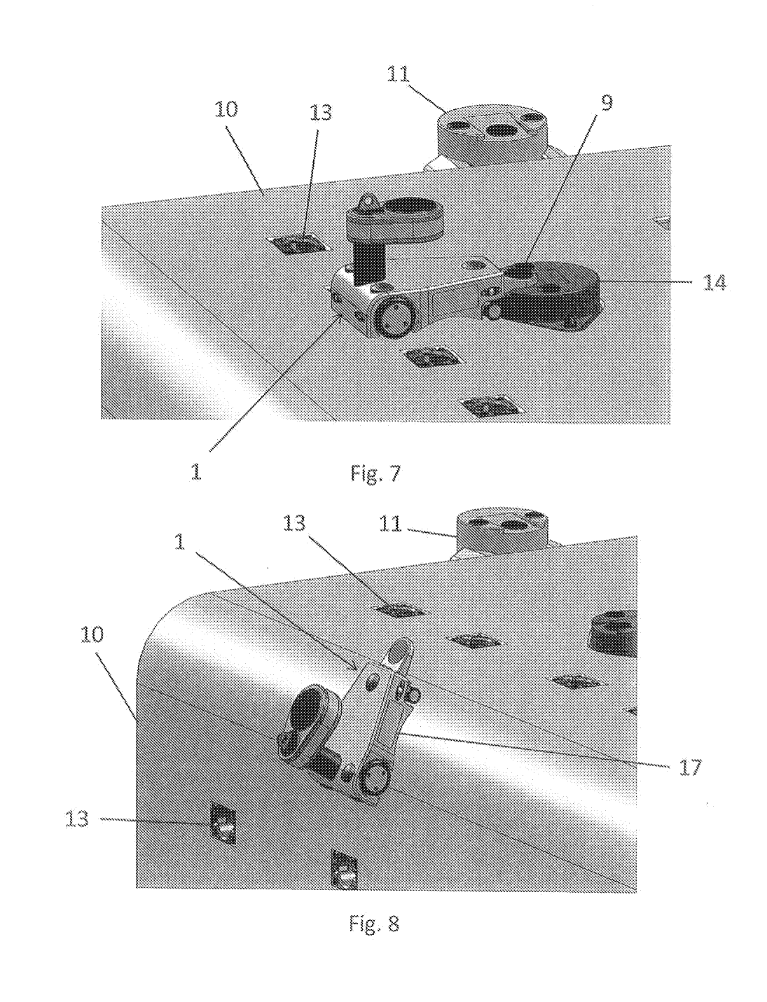

FIG. 7 shows the crawler 1 parked at an actuator 14 for performing an operation such as filling the actuator 14 with hydraulic fluid or charging the actuator 14. The actuator 14 can be hydraulic, electric or a combination thereof. In an alternative embodiment, the sensor modules 15 (ref. FIG. 5) may be charged in the same way as the actuator 14 in the disclosed embodiment.

FIG. 8 shows an embodiment of the invention wherein the crawler 1 is venturing over the side of the subsea structure 10. For the crawler 1 to be able to move over such corners, it is preferably arranged with a cone-shape 17 or any other suitable shape in the part of the crawler body 8 which lies between the wheels in front and the wheels in the back of the crawler body 8.

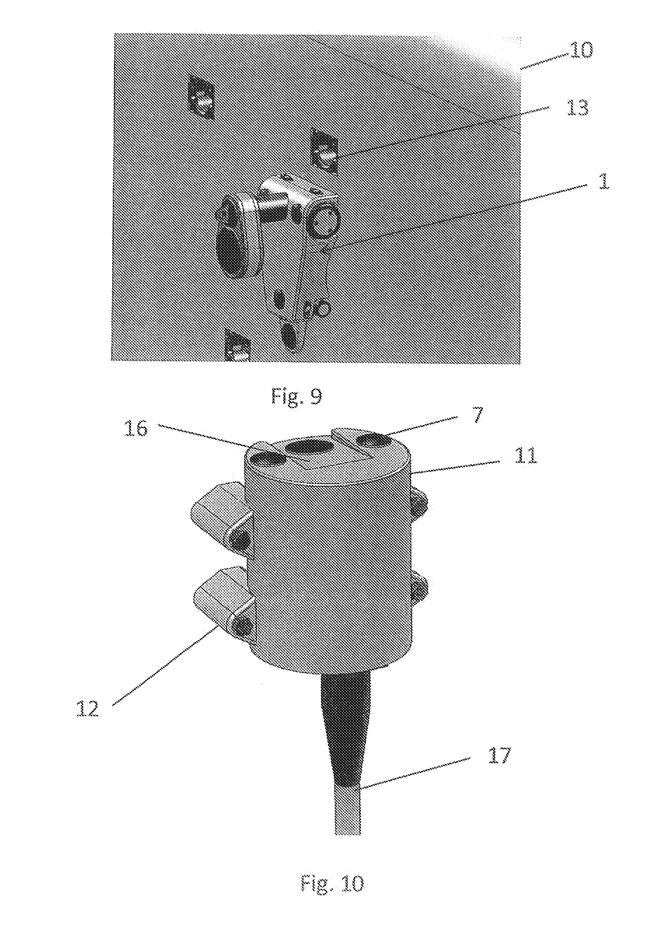

FIG. 9 shows the crawler 1 traversing a vertical face of the subsea structure 10. Sticking means in the wheels 5 or in the crawler body 8 make sure that the crawler 1 sticks to the surface of the subsea structure 10, due to magnetic force, tape or similar means.

FIG. 10 shows an embodiment of a termination head 11 according to the invention. The termination head 11 is connected to a power source through a power connection 17. The power source may be a subsea umbilical, or power may be obtained through an umbilical or wires from the surface, the surrounding seawater, a subsea power plant, a subsea turbine, or energy generated from a well stream, a thermocouple, etc.

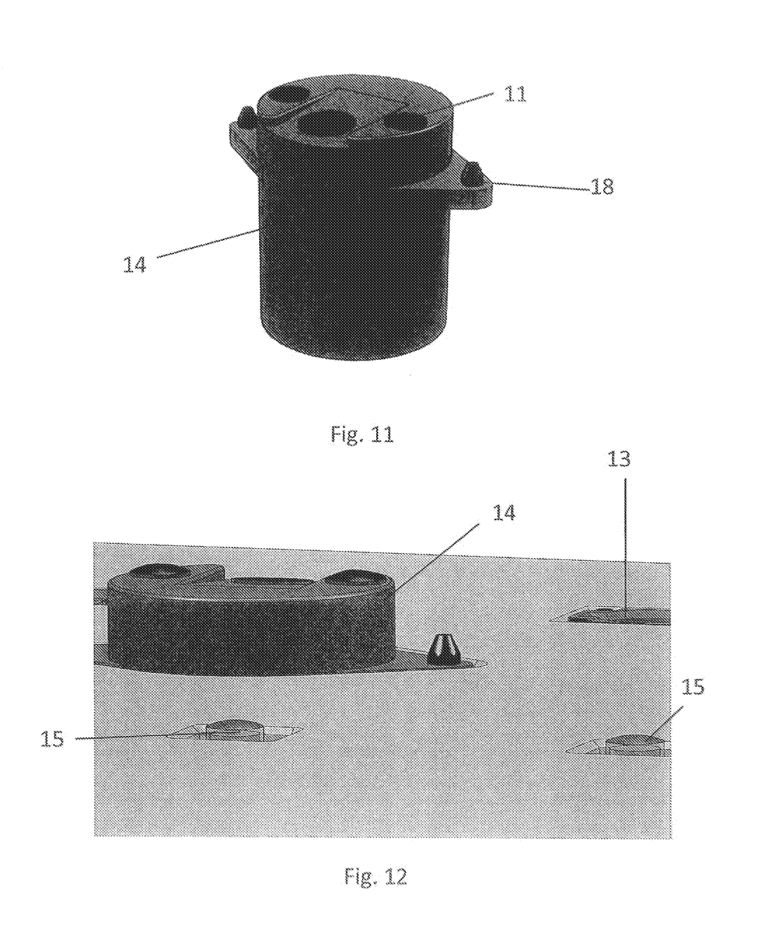

FIG. 11 shows an example of an actuator 14 according to the invention. The actuator may be provided with fastening elements 18 for connection with the subsea structure 10 (not shown).

FIG. 12 shows an example of the view from a forward navigation camera 3 on the crawler 1, showing an actuator 14, sensor modules 15 and a valve 13.

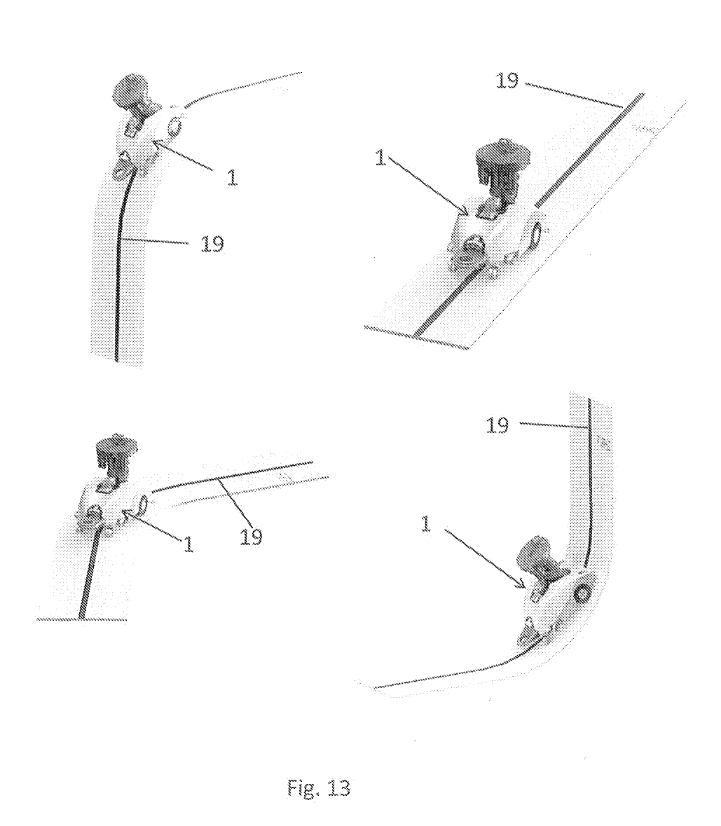

FIG. 13 shows examples of pre-programmed or pre-made safe pathways 19 for the crawler 1 on the subsea system. It shall be understood that the crawler 1 in one embodiment may move in all directions on the surface of the subsea system and that the disclosed pathways 19 are to be considered as being illustrative. In another embodiment the pathways 19 may be pre-formed tracks for the crawler 1 to follow.

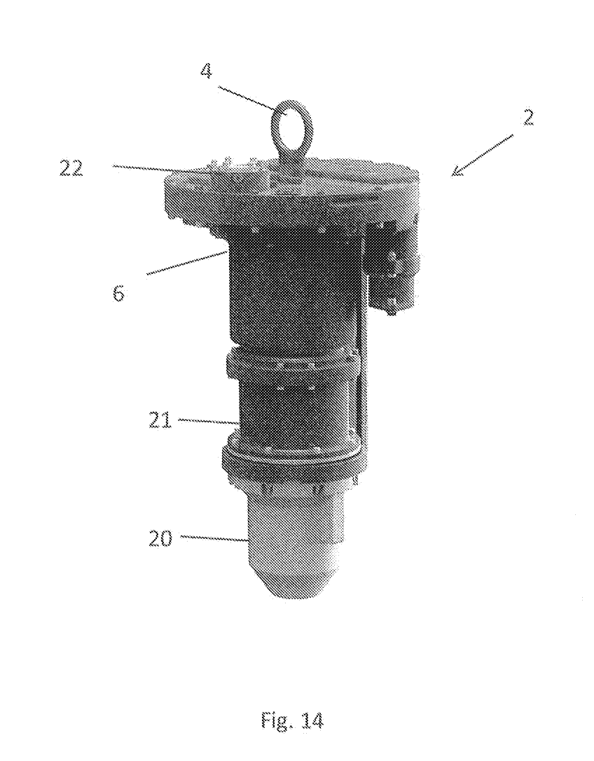

FIG. 14 discloses an embodiment of a torque tool 2 according to the invention. The torque tool 2 comprises lifting means 4 in an upper end thereof. Further, the torque tool 2 comprises a controller 22, a torque tool motor 6, a gear box 21 and sockets 20.

The invention has been described herein in non-limiting embodiments. A person skilled in the art will understand that alterations and modifications to the embodiments may be made that are within the scope of the invention as defined in the attached claims, and that elements or features of the different embodiments may be combined in any configuration.

1. A subsea system comprising:
a subsea installation having at least one negotiable surface and at least one recharge station;
at least one crawler which is freely movable on the negotiable surface;
wherein the crawler has rechargeable means for charging by the recharge station.

2. The subsea system according to claim 1, wherein the subsea installation further comprises at least one umbilical termination head, the umbilical termination head being connectable to at least one power source and being in contact with the recharge station.

3. The subsea system according to claim 2, wherein the recharge station forms part of the umbilical termination head.

4. The subsea system according to claim 1, wherein the subsea installation further comprises communication means, and wherein the crawler has communication functions for communication with the communication means.

5. The subsea system according to claim 4, wherein the communication means and communication functions each comprise wireless communication elements.

6. The subsea system according to claim 1, wherein the crawler comprises a control module pack which is adaptable to control subsea systems to which the crawler attaches.

7. The subsea system according to claim 1, wherein the crawler comprises a number of operating devices for manipulating corresponding subsea components.

8. The subsea system according to claim 7, wherein one of the operating devices comprises an extendable torque tool for manipulating a corresponding subsea component.

9. The subsea system according to claim 1, wherein the system comprises a tool storage device which is accessible for the crawler to retrieve or position a tool to use or unit to be replaced in the subsea system.

10. The subsea system according to claim 1, wherein the crawler has sticking means for maintaining the crawler in contact with the negotiable surface.

11. The subsea system according to claim 1, wherein the crawler comprises a number of navigation cameras.

12. The subsea system according to claim 1, wherein the recharge station and the rechargeable means are inductive.

13. The subsea system according to claim 2, wherein the umbilical termination head is provided with a guiding arrangement for cooperation with an extending portion on the crawler for charging.

14. The subsea system according to claim 1, wherein the crawler has means for re-charging other modules on the subsea installation.

15. The subsea system according to claim 1, wherein the system comprises a subsea installation and subsea structures with negotiable surfaces and a pathway forming a negotiable surface between the installation and the structure.

16. The subsea system according to claim 2, wherein the crawler has means for wireless power transfer to and from the umbilical termination head, another crawler or a power source.
